(19) United States
(12) Patent Application Publication
(10) Pub. No.: US 2007/0120773 A1
(43) Pub. Date: May 31, 2007

(54) Plasma display device, and apparatus and method for driving the same

(76) Inventors: Joon-Yeon Kim, Yongin-si (KR); Hak-Cheol Yang, Yongin-si (KR)

Correspondence Address: CHRISTIE, PARKER & HALE, LLP, PO BOX 7068, PASADENA, CA, 91109-7068, US

(21) Appl. No.: 11/601,046

(22) Filed: Nov. 17, 2006

(30) Foreign Application Priority Data
Nov. 30, 2005 (KR) 10-2005-0115858
Nov. 30, 2005 (KR) 10-2005-0115859

(51) Int. Cl. G09G 3/28

(52) U.S. Cl. 345/68

(57) ABSTRACT

A driving circuit for a plasma display having a plurality of first electrodes is provided. The driving circuit has first and second transistors coupled to first and second power sources, respectively. First and second capacitors are coupled between the drain and the source of the first and second transistors, respectively. A third transistor is coupled between the first power source and a first node, the first node being connected to one of the plurality of first electrodes. A fourth transistor is coupled between the second power source and the first node. A fifth transistor is coupled between a third power source and a second node. A sixth transistor is coupled between the third power source and the second node. An inductor is coupled between the second node and the first node.

### CROSS-REFERENCES TO RELATED APPLICATIONS

This application claims priority to and the benefit of Korean Patent Application No. 10-2005-0115858 filed in the Korean Intellectual Property Office on Nov. 30, 2005, and No.10-2005-0115859 filed in the Korean Intellectual Property Office on Nov. 30, 2005, the entire contents of which are incorporated herein by reference.

### BACKGROUND OF THE INVENTION

1. Field of the Invention

The present invention relates to a plasma display, and an apparatus and method for driving the same.

2. Description of the Related Art

A plasma display is a display device employing a plasma display panel (PDP) configured to display characters and/or images using plasma generated by means of gas discharge. The PDP includes several tens to millions of discharge cells arranged in a matrix format depending on the size of the PDP.

In the plasma display, one field (1 TV field) is driven while it is divided into a plurality of subfields respectively having a weight value. Grayscale is displayed by means of a combination of weight values of subfields in which a display operation is generated of the plurality of subfields. In the address period of each subfield, discharge cells that will emit light and discharge cells that will not emit light are selected by means of an address discharge. In the sustain period, discharge cells to emit light are sustain-discharged during a period corresponding to the weight value of a corresponding subfield, thereby displaying an image.

In particular, in the sustain period, a high level voltage and a low level voltage are alternately applied to electrodes performing the sustain discharge. Accordingly, transistors for applying the high level voltage and the low level voltage must have at least a voltage corresponding to a difference between the high level voltage and the low level voltage as a withstand voltage. The cost of a sustain discharge driving circuit is increased due to transistors having such a high withstand voltage.

### SUMMARY OF THE INVENTION

The present invention has been made in an effort to provide a plasma display using a transistor having a low withstand voltage in a sustain discharge driving circuit, and a driving device and method thereof.

A driving circuit for a plasma display device having a plurality of first electrodes is provided. The driving circuit includes a first transistor, a second transistor, a first charging part, a second charging part, a first charging path, a second charging path, a third transistor, a fourth transistor, a fifth transistor, a sixth transistor, a first resonance path, and a second resonance path. The first transistor has a first transistor first terminal coupled to a first power source for supplying a first voltage, and a first transistor second terminal. The second transistor has a second transistor first terminal coupled to the first transistor second terminal and a second transistor second terminal coupled to a second power source for supplying a second voltage that is lower than the first voltage. The first charging part has a first charging part first terminal coupled to the first power source and a first charging part second terminal coupled to the second transistor first terminal. The second charging part has a second charging part first terminal coupled to the second power source and a second charging part second terminal coupled to the first transistor second terminal. The first charging path includes the first power source, the first charging part, and the second power source to charge the first charging part when the second transistor is turned on. The second charging path includes the first power source, the second charging part, and the second power source to charge the second charging part when the first transistor is turned on. The third transistor has a third transistor first terminal coupled to the first charging part first terminal and a third transistor second terminal coupled to one of the plurality of first electrodes. The fourth transistor has a fourth transistor first terminal coupled to the second charging part first terminal and a fourth transistor second terminal coupled to said one of the plurality of first electrodes. The fifth transistor has a fifth transistor first terminal and a fifth transistor second terminal. The sixth transistor has a sixth transistor first terminal and a sixth transistor second terminal. The first resonance path includes an inductor element coupled between the fifth transistor second terminal and said one of the plurality of first electrodes. The second resonance path includes the inductor element coupled between the sixth transistor first terminal and said one of the plurality of first electrodes. When the fifth transistor first terminal and the sixth transistor second terminal are coupled to each other, both the fifth transistor first terminal and the sixth transistor second terminal are connected to ground. When the fifth transistor first terminal and the sixth transistor second terminal are decoupled, the fifth transistor first terminal is connected to the first charging part and the sixth transistor second terminal is connected to the second charging part.

An exemplary driving circuit having a plurality of first electrodes according to another embodiment of the present invention includes a first transistor, a second transistor, a first capacitor, a second capacitor, a first charging path, a second charging path, a third transistor, a fourth transistor, a fifth transistor, a sixth transistor, a voltage increasing path, and a voltage decreasing path. The first transistor has a first transistor first terminal coupled to a first power source for supplying a first voltage, and a first transistor second terminal. The second transistor has a second transistor first terminal coupled to the first transistor second terminal, and a second transistor second terminal coupled to a second power supply for supplying a second voltage lower than the first voltage. The first capacitor has a first capacitor first terminal coupled to the first transistor first terminal, and a first capacitor second terminal coupled to the first transistor second terminal. The second capacitor has a second capacitor first terminal coupled to the second transistor first terminal, and a second capacitor second terminal coupled to the second transistor second terminal. The first charging path includes the first power supply, the first capacitor, the second transistor, and the second power supply, for charging the first capacitor when the second transistor is turned on. The second charging path includes the first power supply, the first transistor, the second capacitor, and the second power supply, for charging the second capacitor when the first transistor is turned on. The third transistor is coupled between said one of the plurality of first electrodes and the first capacitor first terminal. The fourth transistor is coupled between said one of the plurality of first electrodes and the second capacitor second terminal. The fifth transistor has a fifth transistor first terminal coupled to a third power supply for supplying a third voltage, which is lower than the first voltage but higher than the second voltage, and a fifth transistor second terminal connected to said one of the plurality of first electrodes. The sixth transistor has a sixth transistor first terminal coupled to the third power supply, and a sixth transistor second terminal coupled to said one of the plurality of first electrodes. The voltage increasing path is connected between the fifth transistor second terminal and said one of the plurality of first electrodes, for raising a voltage of the plurality of first electrodes. The voltage decreasing path is connected between the sixth transistor second terminal and said one of the plurality of first electrodes, for lowering the voltage of said one of the plurality of first electrodes.

An exemplary driving circuit for a plasma display having a plurality of first electrodes includes a first transistor, a second transistor, a first capacitor, a second capacitor, a third capacitor, a fourth capacitor, a first charging path, a second charging path, a third transistor, a fourth transistor, a fifth transistor, a sixth transistor, a first voltage increasing path, a second voltage increasing path, a first voltage decreasing path, and a second voltage decreasing path. The first transistor has a first transistor first terminal coupled to a first power source for supplying a first voltage, and a first transistor second terminal. The second transistor has a second transistor first terminal coupled to the first transistor second terminal and a second transistor second terminal coupled to a second power source for supplying a second voltage that is lower than the first voltage. The first capacitor has a first capacitor first terminal coupled to the first transistor first terminal, and a first capacitor second terminal. The second capacitor has a second capacitor first terminal coupled to the first capacitor second terminal and a second capacitor second terminal coupled to the second transistor first terminal. The third capacitor has a third capacitor first terminal coupled to the first transistor second terminal, and a third capacitor second terminal. The fourth capacitor has a fourth capacitor first terminal coupled to the third capacitor second terminal and a fourth capacitor second terminal coupled to the second power source. The first charging path includes the first power source, the first capacitor, the second capacitor, the second transistor, and the second power source, for charging the first capacitor and the second capacitor when the second transistor is turned on. The second charging path includes the first power source, the first transistor, the third capacitor, the fourth capacitor, and the second power source, for charging the third capacitor and the fourth capacitor when the first transistor is turned on. The third transistor is coupled between one of the plurality of first electrodes and the first capacitor first terminal. The fourth transistor is coupled between said one of the plurality of first electrodes and the fourth capacitor second terminal. The fifth transistor has a fifth transistor first terminal coupled to the second capacitor first terminal and a fifth transistor second terminal coupled to said one of the plurality of first electrodes. The sixth transistor has a sixth transistor first terminal coupled to the third capacitor second terminal and a sixth transistor second terminal coupled to said one of the plurality of first electrodes. The first voltage increasing path includes the second power source, the second transistor, the second capacitor, and the fifth transistor, the fifth transistor being coupled to said one of the plurality of first electrodes to increase a voltage of said one of the plurality of first electrodes. The second voltage increasing path includes the first power source, the first transistor, the second capacitor, and the fifth transistor, the fifth transistor being coupled to said one of the plurality of first electrodes to increase the voltage of said one of the plurality of first electrodes. The first voltage decreasing path includes the first power source, the first transistor, the third capacitor, and the sixth transistor, the sixth transistor being coupled to said one of the plurality of first electrodes to decrease the voltage of said one of the plurality of first electrodes. The second voltage decreasing path includes the second power source, the second transistor, the third capacitor, and the sixth transistor, the sixth transistor being coupled to said one of the plurality of first electrodes to decrease the voltage of said one of the plurality of first electrodes.

In an exemplary method of driving a plasma display device having a plurality of first electrodes, the method includes applying a fourth voltage to the plurality of first electrodes through a first power supply for supplying a first voltage and through a first capacitor carrying a first capacitor voltage. Also, the method includes increasing a first electrode voltage to the plurality of first electrodes through a first resonance path, the first resonance path including a second power supply and an inductor element, the second power supply supplying a second voltage higher than the first voltage. Furthermore, the method includes applying a fifth voltage to the plurality of first electrodes through a third power supply for supplying a third voltage and through a second capacitor carrying a second capacitor voltage, the third voltage being higher than the second voltage. In addition, the method includes decreasing the first electrode voltage through a second resonance path, the second resonance path including the second power supply and the inductor element.

In an exemplary method of driving a plasma display device having a plurality of first electrodes, the method includes applying a fourth voltage to the plurality of first electrodes through a first power source for supplying a first voltage and through a first capacitor carrying a first capacitor voltage and a second capacitor carrying a second capacitor voltage. The method also includes increasing the first electrode voltage to the plurality of first electrodes through a first resonance path, the first resonance path including the first power source and an inductor element. In addition, the method includes applying a fifth voltage to the plurality of first electrodes by the second power source for supplying a second voltage that is higher than the first voltage. Furthermore, the method includes further increasing the first electrode voltage through a second resonance path, the second resonance path including the second power source and the inductor element. Moreover, the method includes applying a sixth voltage to the plurality of first electrodes through the second power source and through a third capacitor charged with a third capacitor voltage and a fourth capacitor charged with a fourth capacitor voltage. Additionally, the method includes decreasing the first electrode voltage through the a third resonance path, the third resonance path including the second power source and the inductor element. Furthermore, the method includes applying a seventh voltage to the plurality of first electrodes by the first power source. In addition, the method includes further decreasing the first electrode voltage through a fourth resonance path, the fourth resonance path including the first power source and the inductor element.

### BRIEF DESCRIPTION OF THE DRAWINGS

FIG. 1 is a view showing a plasma display according to an exemplary embodiment of the present invention.

FIGS. 2, 3, and 4 are views illustrating driving waveforms of the plasma display according to first, second, and third exemplary embodiments of the present invention, respectively.

FIG. 5 shows a sustain discharge driving circuit of a scan electrode driver for generating the driving waveform shown in FIG. 4.

FIG. 6 is a signal timing diagram of the sustain discharge driving circuit for generating the driving waveform shown in FIG. 4.

FIGS. 7A, 7B, 7C, and 7D are circuit diagrams illustrating an operation of a sustain discharge driving circuit shown in FIG. 5 according to the signal timing diagram shown in FIG. 6.

FIG. 8 is a view representing a sustain discharge driving circuit of the scan electrode driver according to the second exemplary embodiment of the present invention.

FIG. 9 is a signal timing diagram of the sustain discharge driving circuit according to the second exemplary embodiment of the present invention.

FIGS. 10A, 10B, 10C, 10D, 10E, 10F, 10G, and 10H are circuit diagrams illustrating an operation of a sustain discharge driving circuit shown in FIG. 5 according to the second exemplary embodiment of the present invention.

FIG. 11 shows another embodiment of a sustain discharge driving circuit of a scan electrode driver for generating the driving waveform shown in FIG. 4.

FIG. 12 is a view representing another embodiment of a sustain discharge driving circuit of the scan electrode driver according to the second exemplary embodiment of the present invention.

### DETAILED DESCRIPTION

In the specification, when it is said that any part is “connected” to another part, it means the part is “directly connected” to the other part or is “electrically connected” to the other part with one intermediate part therebetween. Furthermore, when it is said that any part “includes” any constituent elements, it means the part may further include other constituent elements unless otherwise described without excluding other constituent elements.

In the specification, the term “voltage is maintained” includes that although a potential difference between two points changes as times goes by, the change falls within a range that is allowable in design, or the cause of the change resides in parasitic components, which can be disregarded in design practice by a person of ordinary skill in the art. Further, because the threshold voltage of semiconductor devices (for example transistors, diodes, and the like) is very low compared with a discharge voltage, the threshold voltage is considered to be 0V and is thus processed approximately.

A plasma display and a method and apparatus for driving the same according to an embodiment of the present invention will be first described in detail with reference to the drawings.

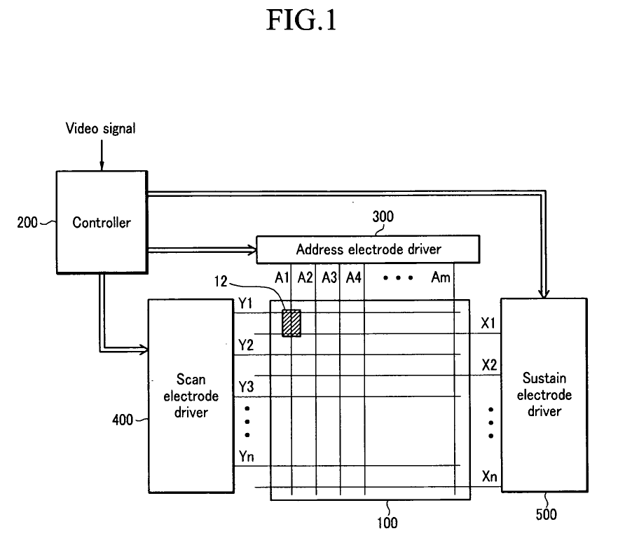

FIG. 1 is a view showing a plasma display according to an exemplary embodiment of the present invention.

As shown in FIG. 1, the plasma display according to an exemplary embodiment of the present invention includes a PDP 100, a controller 200, an address electrode driver 300, a scan electrode driver 400, and a sustain electrode driver 500.

The PDP 100 includes a plurality of address electrodes (hereinafter referred to as “A electrodes”) A1 to Am extending in a column direction, a plurality of sustain electrodes (hereinafter referred to as “X electrodes”) X1 to Xn extending in pairs in a row direction, and scan electrodes (hereinafter referred to as “Y electrodes”) Y1 to Yn. In general, the X electrodes X1 to Xn are formed corresponding to the Y electrodes Y1 to Yn, respectively. The X electrodes and Y electrodes perform a display operation for displaying an image in the sustain period. The Y electrodes Y1 to Yn and the X electrodes X1 to Xn are disposed to cross the A electrodes A1 to Am. A discharge space at a crossing region of the A electrodes A1 to Am and the X and Y electrodes X1 to Xn and Y1 to Yn forms a cell 12. It is to be noted that the construction of the PDP is only an example, and panels having different structures, to which a driving waveform to be described later can be applied, may be applied to the present invention.

The controller 200 receives an external video signal, and outputs an address (A) electrode driving control signal, a sustain (Y) electrode driving control signal, and a scan (X) electrode driving control signal. The controller 200 drives one frame that is divided into a plurality of subfields. Each subfield includes an address period and a sustain period.

The address electrode driver 300 receives the A electrode driving control signal from the controller 200, and applies a display data signal for selecting a discharge cell on which an image will be displayed to each electrode.

The scan electrode driver 400 receives the Y electrode driving control signal from the controller 200, and applies a driving voltage to the Y electrode.

The sustain electrode driver 500 receives the X electrode driving control signal from the controller 200, and applies a driving voltage to the X electrode.

The plasma display according to the exemplary embodiment of the present invention may have various types of driving waveforms.

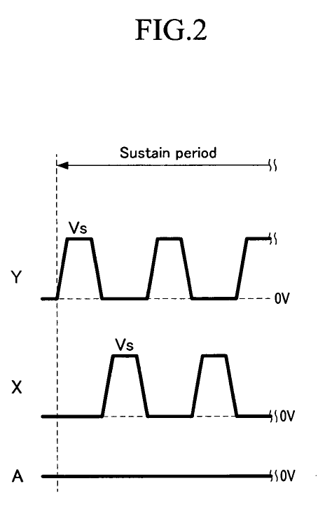

The various types of driving waveforms are exemplified in FIG. 2 to FIG. 4.

For convenience of descriptions, a driving waveform applied to the Y, X, and A electrodes forming one cell will be described, in FIG. 2 to FIG. 4.

As shown in FIG. 2, in a driving waveform according to the first exemplary embodiment of the present invention (hereinafter, referred to as a “first driving waveform”), a sustain pulse has a high level voltage (Vs voltage) and a low level voltage (0V voltage), and sustain pulses of opposite phases are alternately applied to the Y and X electrodes during the sustain period. The sustain pulse is repeatedly applied to the Y electrode and the X electrode as many times as a number corresponding to a weight value displayed by a corresponding subfield. In other words, when the voltage Vs is applied to the Y electrode, the 0V voltage is applied to the X electrode, and when the voltage Vs is applied to the X electrode, the 0V voltage is applied to the Y electrode. By doing so, a voltage difference between each Y electrode and each X electrode is alternately the voltage Vs and the voltage −Vs. Accordingly, a sustain discharge is repeatedly generated in a turned on discharge cell as many times as the number corresponding to the weight value.

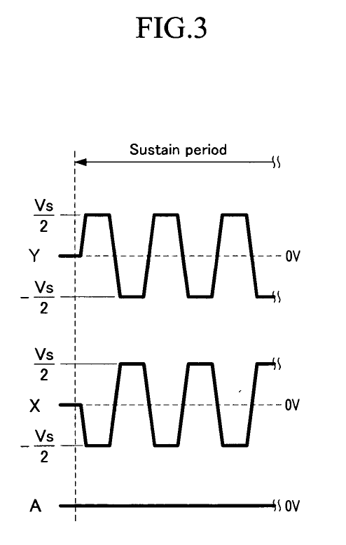

As shown in FIG. 3, by the driving waveforms according to the second exemplary embodiment of the present invention (hereinafter, referred to as a “second driving waveform”), a sustain pulse alternately having a high level voltage (a Vs/2 voltage) and a low level voltage (a −Vs/2 voltage) may be applied to the Y electrode and the X electrode as opposite phases. In other words, when the voltage Vs/2 is applied to the Y electrode, the voltage −Vs/2 is applied to the X electrode, and when the voltage Vs/2 is applied to the X electrode, the voltage −Vs/2 is applied to the Y electrode. Even in this case, in the same manner as the sustain pulse of FIG. 2, a voltage difference between the X electrode and the Y electrode may alternately be the voltage Vs and the voltage −Vs.

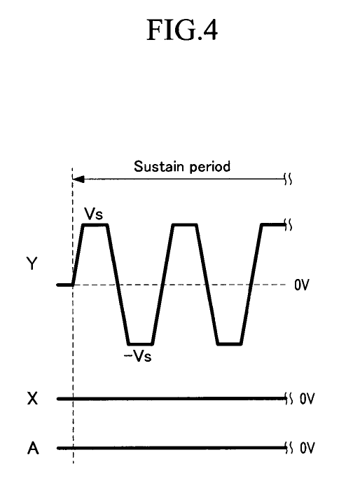

The first and second exemplary embodiments of the present invention provide an example in which the sustain pulse alternately having the high level voltage and the low level voltage is applied to the X electrode and the Y electrode as opposite phases. However, the sustain pulse may also be applied only to either the X electrode or the Y electrode. An exemplary embodiment of applying the sustain pulse to only one electrode will be described in detail hereunder with reference to FIG. 4.

FIG. 4 is a view illustrating a driving waveform (hereinafter, referred to as a “third driving waveform”) of the plasma display according to a third exemplary embodiment of the present invention.

Referring to FIG. 4, in the sustain period, a sustain pulse alternately having a voltage Vs and a voltage −Vs is applied to the Y electrode with a 0V voltage being applied to the X electrode. In this case, in the same manner as the sustain pulse of FIG. 2, a voltage difference of the X electrode and the Y electrode can alternately be the voltage Vs and the voltage −Vs.

Two sustain discharge circuits for generating the first to third driving waveforms will now be described.

The sustain discharge driving circuit generates the sustain pulse.

In addition, the sustain discharge driving circuit is formed in either the scan electrode driver or the sustain electrode driver, or in both, according to the driving waveforms.

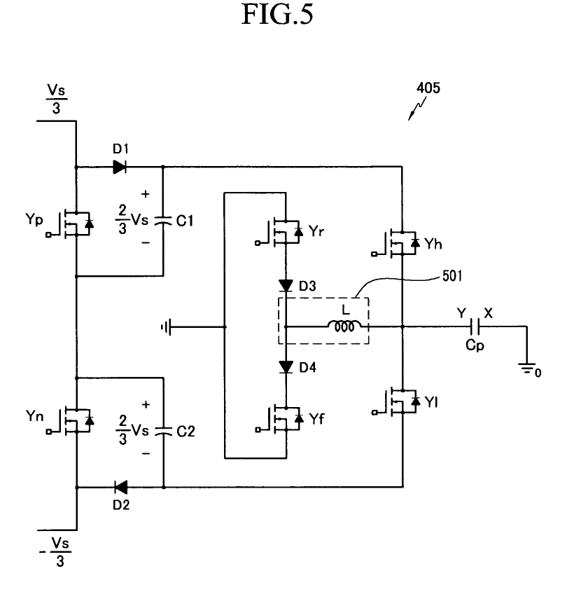

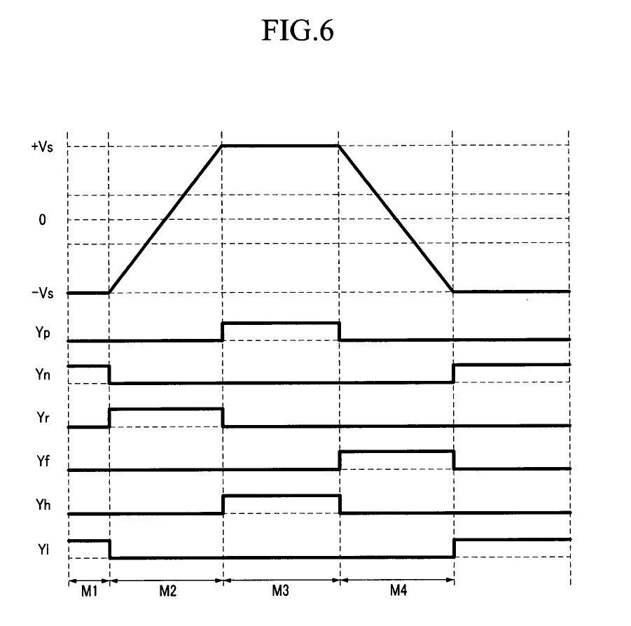

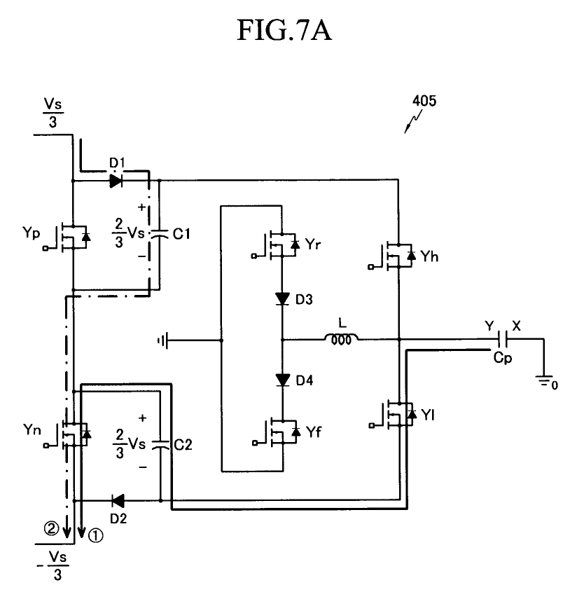

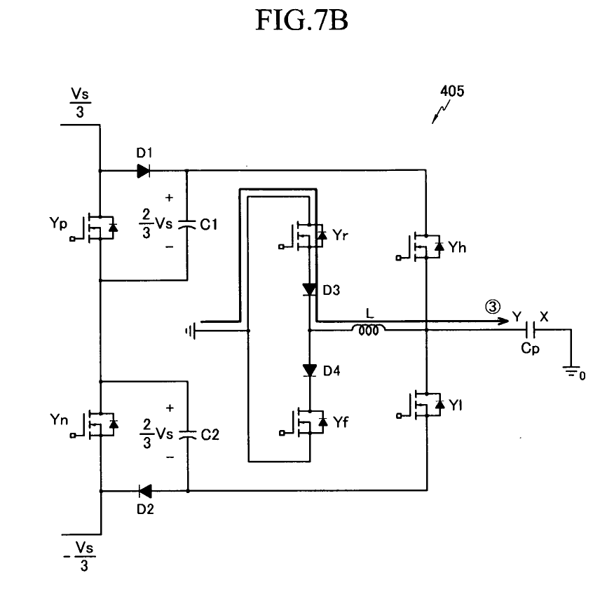

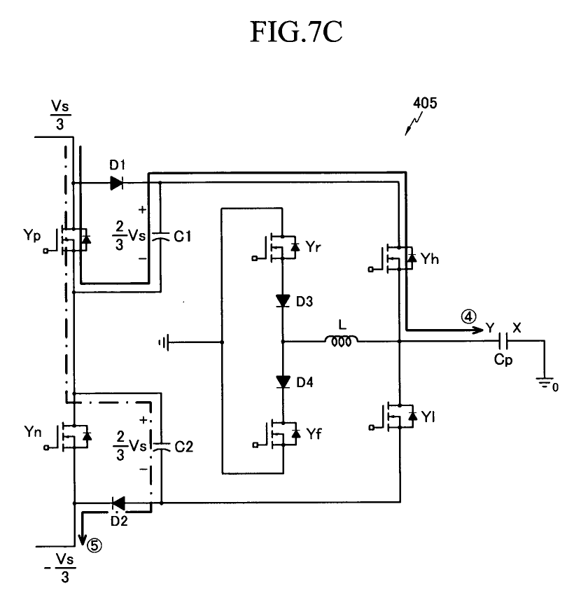

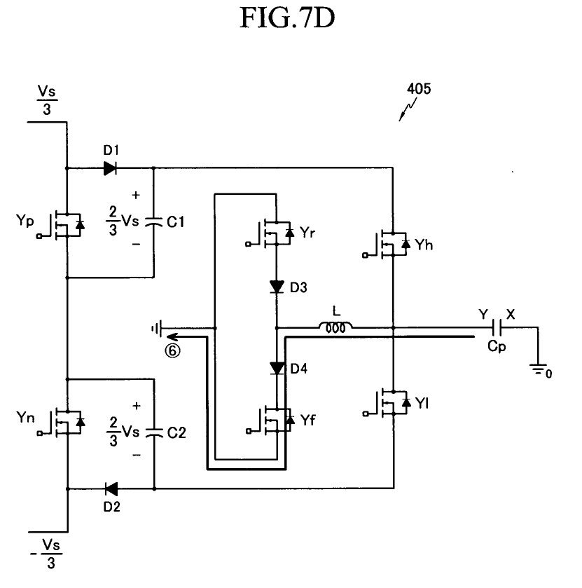

The sustain discharge driving circuit according to the first exemplary embodiment of the present invention, and an operation thereof, will now be described with reference to FIG. 5, FIG. 6, and FIG. 7A to FIG. 7D. The third driving waveform will be described first, and then the first and second driving waveforms will be described.

FIG. 5 shows a sustain discharge driving circuit 405 of the scan electrode driver 400 for generating the driving waveform of FIG. 4. In FIG. 5, only a sustain discharge driving circuit connected to the plurality of Y electrodes Y1 to Yn is shown for better understanding and ease of description. The sustain discharge driving circuit may be formed in the scan electrode driver 400 of FIG. 1. In FIG. 5, it is also shown that during the sustain period, the X electrodes X to Xn are applied with the 0V voltage, and therefore the plurality of X electrodes X to Xn are connected to a ground terminal 0 for supplying a ground voltage 0V. In the case of the driving waveforms of FIGS. 2 and 3, a sustain discharge driving circuit having the same construction as that of the sustain discharge driving circuit of FIG. 5 may be connected to a plurality of X electrodes. In the sustain discharge driving circuit constructed above, only one X electrode and one Y electrode are illustrated for better understanding and ease of description. A capacitive component formed by the X electrode and the Y electrode is indicated by a panel capacitor Cp.

In FIG. 5, it is shown that transistors Yp, Yn, Yr, Yf, Yh, Yl are channel field effect transistors, particularly n-channel metal oxide semiconductor (NMOS) transistors. A body diode may be formed in the transistors Yp, Yn, Yr, Yf, Yh, Yl from a source direction to a drain direction. Other transistors having a similar function as that of the NMOS transistor may be used as the transistors Yp, Yn, Yr, Yf, Yh, Yl instead of the NMOS transistors.

Furthermore, in FIG. 5, the transistors Yp, Yn, Yr, Yf, Yh, Yl are each shown as one transistor. However, the transistors Yp, Yn, Yr, Yf, Yh, Yl may each be formed of a plurality of transistors coupled in parallel. Furthermore, the transistors Yp, Yn, Yr, Yf, Yh, Yl may each be formed of more than one transistor coupled in series, which would reduce the requisite withstand voltage for each transistor.

The transistor Yp has a drain connected to a power supply Vs/3 for supplying a Vs/3 voltage corresponding to ⅓ of a high level voltage Vs of the sustain pulse, and a source connected to a drain of the transistor Yn. The transistor Yn has a source connected to a power supply −Vs/3 for supplying a voltage −Vs/3 corresponding to ⅓ of a high level voltage −Vs of the sustain pulse.

A capacitor C1 has a first terminal connected to a node of the drain of the transistor Yp and the power supply Vs/3, and a second terminal connected to the source of the transistor Yp. A capacitor C2 has a first terminal connected to the drain of the transistor Yn, and a second terminal connected to a node of the source of the transistor Yn and the power supply −Vs/3.

A diode D1 has an anode connected to the power supply Vs/3, and a cathode connected to the first terminal of the capacitor C1. A diode D2 has a cathode connected to the power supply −Vs/3, and an anode connected to the second terminal of the capacitor C2.

The diodes D1, D2 form a charging path along which the capacitors C1 and C2 are respectively charged with a voltage 2Vs/3 when the transistors Yn, Yp are respectively turned on. Other elements (e.g., transistors) capable of forming the charging path may also be used instead of the diodes D1, D2. In FIG. 5, it is assumed that the capacitors C1 and C2 have the same capacitance and are charged with a voltage 2Vs/3 by means of the charging path.

The transistor Yh has a drain connected to the first terminal of the capacitor C1, and a source connected to a Y electrode of the panel capacitor Cp. The transistor Yl has a source connected to the second terminal of the capacitor C2, and a drain connected to the Y electrode of the panel capacitor Cp.

A power supply 0V is connected to a node of a drain of the transistor Yr and a source of the transistor Yf, and a node of a source of the transistor Yr and a drain of the transistor Yf are connected to a first terminal of an inductor L. The inductor L has a second terminal connected to the Y electrode of the panel capacitor Cp.

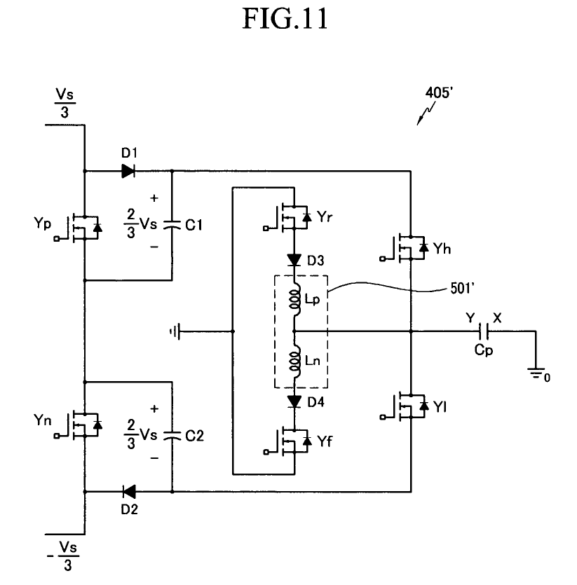

FIG. 5 shows a dotted line 501 around the inductor L. The dotted line 501 is an inductor element. In this particular embodiment, the inductor element may contain one inductor as shown in FIG. 5 or multiple inductors as shown in FIG. 11.

A diode D3 has an anode connected to the source of the transistor Yr, and a cathode connected to the first terminal of the inductor L. A diode D4 has a cathode connected to the drain of the transistor Yf, and an anode connected to the first terminal of the inductor L.

The diode D3 is intended to set a voltage increasing path for shielding a current path formed by the body diode of the transistor Yr and raising the voltage of the Y electrode, and the diode D4 is intended to set a voltage decreasing path for shielding a current path formed by the body diode of the transistor Yf and lowering the voltage of the Y electrode.

It has been shown in FIG. 5 that one inductor L is connected to the node of the diodes D3 and D4. However, the inductor may be connected to the voltage increasing path and the voltage decreasing path, respectively.

The operation of the sustain discharge driving circuit 405 of FIG. 5 will be described in detail below with reference to FIGS. 6 and 7A to 7D.

FIG. 6 is a signal timing diagram of the sustain discharge driving circuit for generating the driving waveform of FIG. 4. FIGS. 7A to 7D are circuit diagrams illustrating the operation of the sustain discharge driving circuit 405 of FIG. 5 according to the signal timing diagram of FIG. 6. It is first assumed that before a mode 1 (M1) begins, the transistor Yf has turned on and the remaining transistors Yp, Yn, Yr, Yh, Yl have turned off.

Referring to FIGS. 6 and 7A, in M1, the transistor Yf is turned off and the transistors Yl, Yn are turned on. Accordingly, as shown in FIG. 7A, the voltage −Vs is applied to the Y electrode along the path connecting the Y electrode of the panel capacitor Cp, the transistor Yl, the capacitor C2, the transistor Yn, and the power supply −Vs/3 in this sequence (\textcircled{1}). Namely, the voltage −Vs is applied to the Y electrode, which is lower by the voltage 2Vs/3 charged to the capacitor C2 than the power supply voltage −Vs/3.

The transistor Yn is turned on with the transistor Yp being turned off, thus forming a path connecting the power supply Vs/3, the diode D1, the capacitor C1, the transistor Yn, and the power supply −Vs/3 in this sequence (\textcircled{2}). Accordingly, the capacitor C1 is charged with the voltage 2Vs/3 corresponding to a difference between voltages applied to the power supply Vs/3 and the power supply −Vs/3.

At this time, the source voltage of the transistor Yh becomes the voltage −Vs by means of the path \textcircled{1}, and the drain voltage of the transistor Yh becomes the Vs/3 voltage by means of the path (\textcircled{2}). Thus, a voltage 4Vs/3 is applied between the source and drain of the transistor Yh. Therefore, the transistor Yh should have a withstand voltage of 4Vs/3.

Furthermore, the source voltage of the transistor Yp is the voltage −Vs/3 and the drain voltage of the transistor Yp is the Vs/3 voltage. Thus, the transistor Yp should have a withstand voltage of 2Vs/3.

Thereafter, in a mode 2 (M2), the transistor Yr is turned on, and the transistors Y1, Yn are turned off. Thus, resonance is generated along a path connecting the ground terminal 0V, the transistor Yr, the diode D3, the inductor L, and the Y electrode of the panel capacitor Cp in this sequence, as shown in FIG. 7B (\textcircled{3}). At this time, the first terminal of the inductor L is applied with the voltage of the ground terminal 0V, and the second terminal thereof is applied with the voltage −Vs. Accordingly, a voltage applied to the Y electrode of the panel capacitor Cp though LC resonance rises from the voltage −Vs to the voltage Vs.

In a mode 3 (M3), the transistor Yr is turned off, and the transistors Yh, Yp are turned on. Accordingly, the voltage −Vs is applied to the Y electrode along a path connecting the power supply Vs/3, the transistor Yp, the capacitor C1, the transistor Yh, and the Y electrode of the panel capacitor Cp in this sequence, as shown in FIG. 7C (\textcircled{4}). In other words, the Y electrode is applied with the voltage Vs, which is higher by the voltage 2Vs/3 charged to the capacitor C1 than the power supply voltage Vs/3.

The transistor Yp is turned on with the transistor Yn being turned off, thus forming a path connecting the power supply Vs/3, the transistor Yp, the capacitor C2, the diode D2, and the power supply −Vs/3 in this sequence \textcircled{5}. Accordingly, the capacitor C2 is charged with the voltage 2Vs/3 corresponding to a difference between the voltages applied to the power supply Vs/3 and the power supply −Vs/3.

At this time, the drain voltage of the transistor Yl becomes the voltage Vs by means of the path (\textcircled{4}), and the source voltage of the transistor Yl becomes the voltage −Vs/3 by means of the path (\textcircled{5}). Thus, the voltage 4Vs/3 is applied between the source and drain of the transistor Yl. Therefore, the transistor Yl should have a withstand voltage of 4Vs/3.

The source voltage of the transistor Yn is the voltage −Vs/3, and the drain voltage of the transistor Yn is the voltage Vs/3. Accordingly, the transistor Yn should have a withstand voltage of 2Vs/3.

In a mode 4 (M4), the transistor Yf is turned on and the transistors Yh, Yp are turned off. Accordingly, resonance occurs along a path connecting the Y electrode of the panel capacitor Cp, the inductor L, the diode D4, the transistor Yf, and the power supply voltage 0V in this sequence, as shown in FIG. 7D (\textcircled{6}). Thus, energy stored in the panel capacitor Cp is recovered by the power supply 0V through the inductor L, and at the same time, the voltage of the Y electrode drops from the voltage Vs to the voltage −Vs.

As described above, during the sustain period, the modes 1 to 4 are repeatedly performed as many times as a number corresponding to a weight value of a corresponding subfield, so that the Y electrode can be alternately applied with the voltage Vs and the voltage −Vs. Furthermore, the transistors Yh, Yl should have a withstand voltage corresponding to ⅔ of the voltage swing applied to the Y electrode, i.e., a withstand voltage of 4Vs/3. The transistors Yp, Yn should have a withstand voltage of 2Vs/3.

Generation of the driving waveform according to the third exemplary embodiment of the present invention has been described above with reference to FIGS. 7A to 7D. However, it is to be understood that the driving waveforms according to the first and the second exemplary embodiments of the present invention may be generated using the circuit of FIG. 5.

Specifically, in the circuit of FIG. 5, the drain of the transistor Yp can be connected to the power supply that supplies the voltage 2Vs/3, the source of the transistor Yn can be connected to the power supply that supplies the voltage Vs/3, and the power supply that supplies the voltage Vs/2 can be connected to the node of the drain of the transistor Yr and the source of the transistor Yf. When the transistor Yn and the transistor Yp are turned on, the capacitor C1 and the capacitor C2 are respectively charged with the voltage Vs/3. Accordingly, a sustain pulse alternately having the voltage Vs and the voltage 0V can be applied to the Y electrode through the same path as that shown in FIGS. 7A to 7D. Furthermore, the sustain discharge driving circuit connected to the X electrode has the same construction as that of the sustain discharge driving circuit 405 connected to the Y electrode. The sustain discharge driving circuit connected to the X electrode can apply the voltage 0V to the X electrode while the voltage Vs is applied to the Y electrode, and can apply the voltage Vs to the X electrode while the voltage Vs is applied to the Y electrode.

Furthermore, in the circuit of FIG. 5, the drain of the transistor Yp can be connected to a power supply for supplying a voltage Vs/6, and the source of the transistor Yn can be connected to a power supply for supplying a voltage −Vs/6. When the transistor Yn and the transistor Yp are turned on, the capacitor C1 and the capacitor C2 are charged with the voltage Vs/3. A sustain pulse alternately having the voltage Vs/2 and the voltage −Vs/2 can be applied to the Y electrode along the same path as that shown in FIGS. 7A to 7D. The sustain discharge driving circuit connected to the X electrode has the same construction as that of the sustain discharge driving circuit 405 connected to the Y electrode, and the sustain discharge driving circuit connected to the X electrode may apply a sustain pulse alternately having the voltage Vs/2 and the voltage −Vs/2 to the X electrode as an opposite phase to that of a sustain pulse applied to the Y electrode.

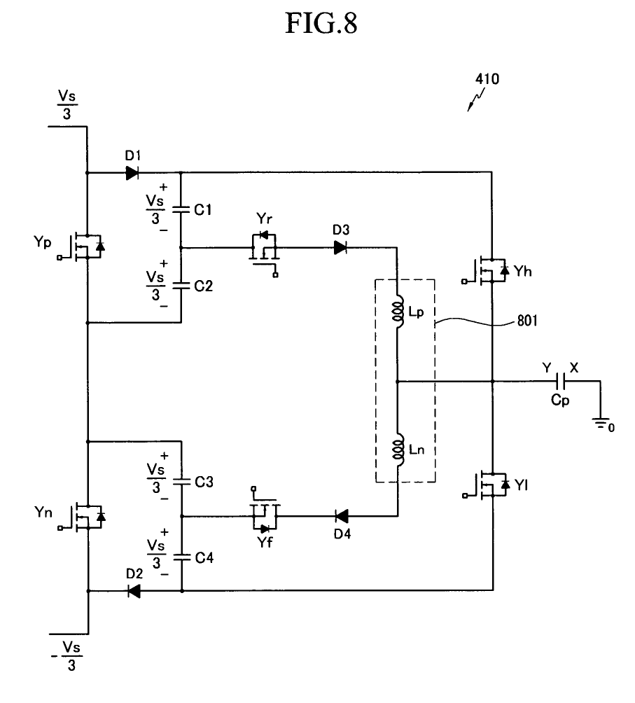

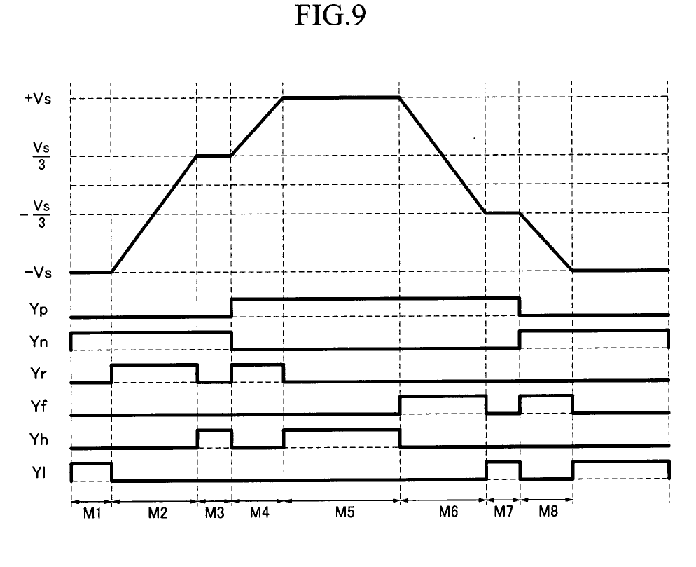

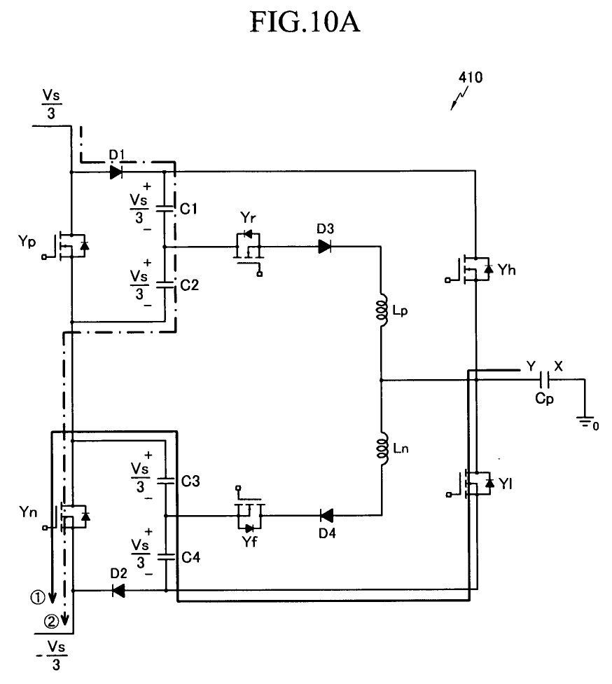

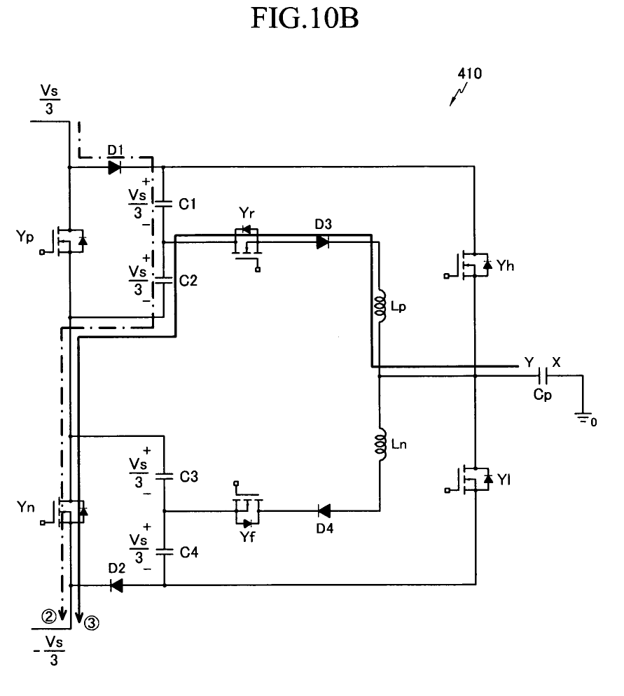

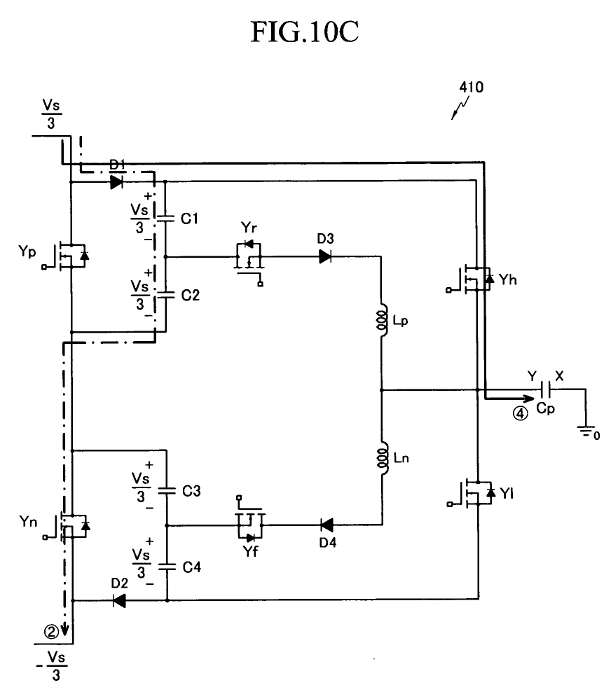

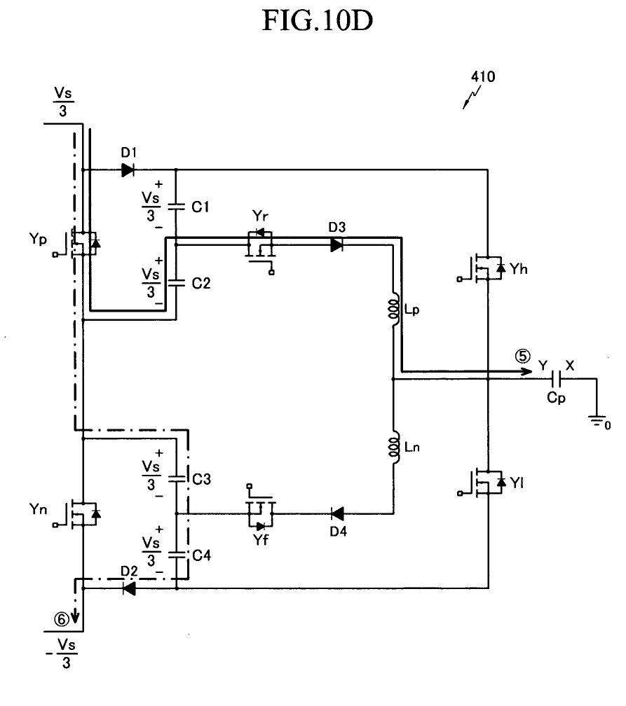

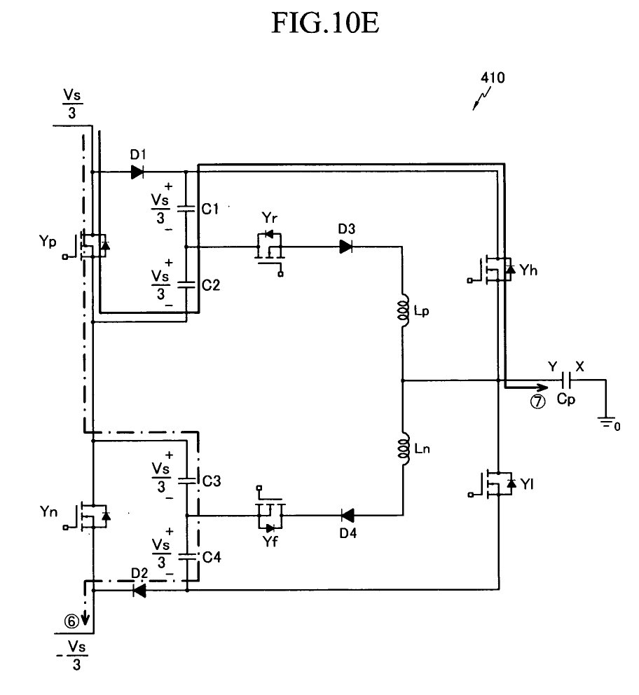

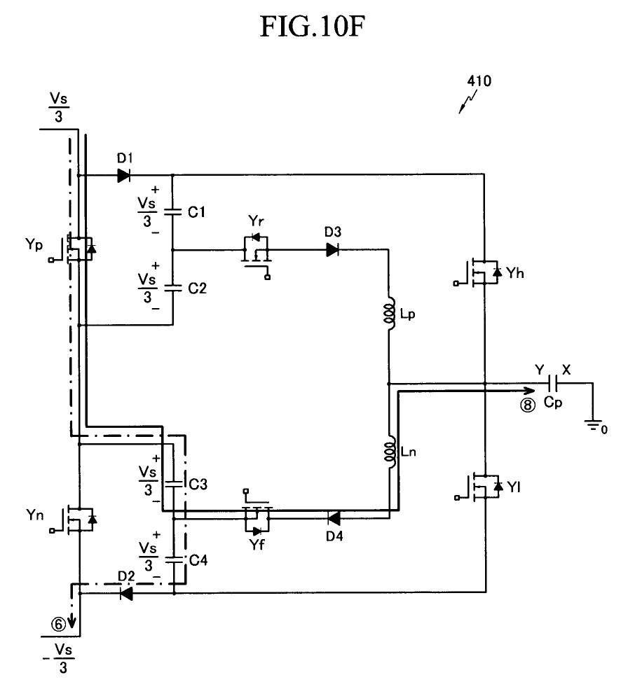

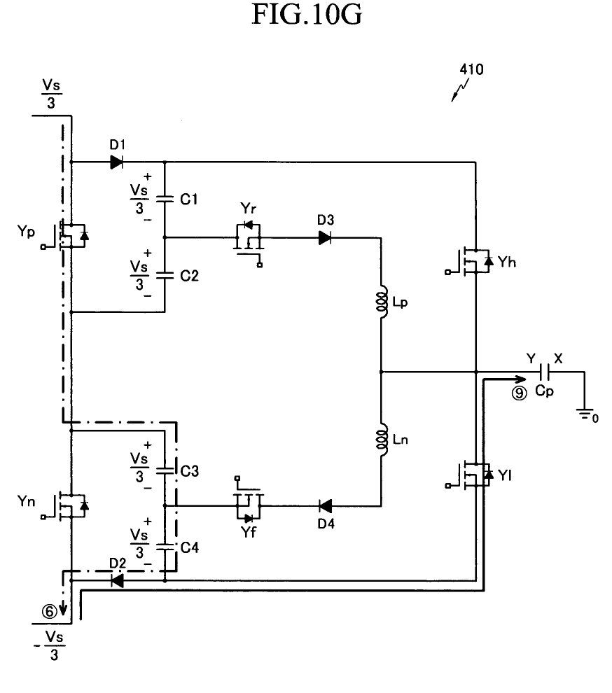

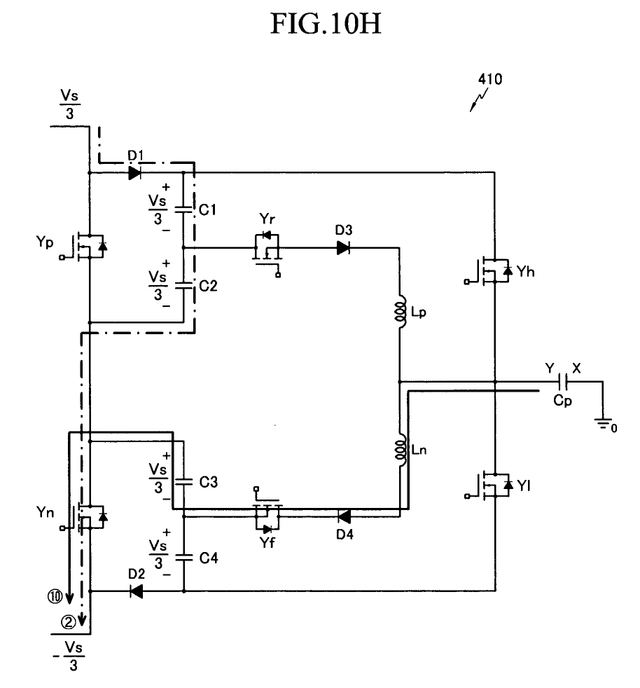

A sustain discharge driving circuit 410 according to a second exemplary embodiment of the present invention and an operation thereof will now be described with reference to FIG. 8, FIG. 9, and FIG. 10A to FIG. 10H. The third driving waveform will be described first, and then the first and second driving waveforms will be described.

FIG. 8 is a view representing a sustain discharge driving circuit 410 of the scan electrode driver according to the second exemplary embodiment of the present invention.

As shown in FIG. 8, the sustain discharge driving circuit includes transistors Yp, Yn, Yr, Yf, Yh, Yl, capacitors C1, C2, C3, and C4, inductors Lp, Ln, and diodes D1, D2, D3, D4.

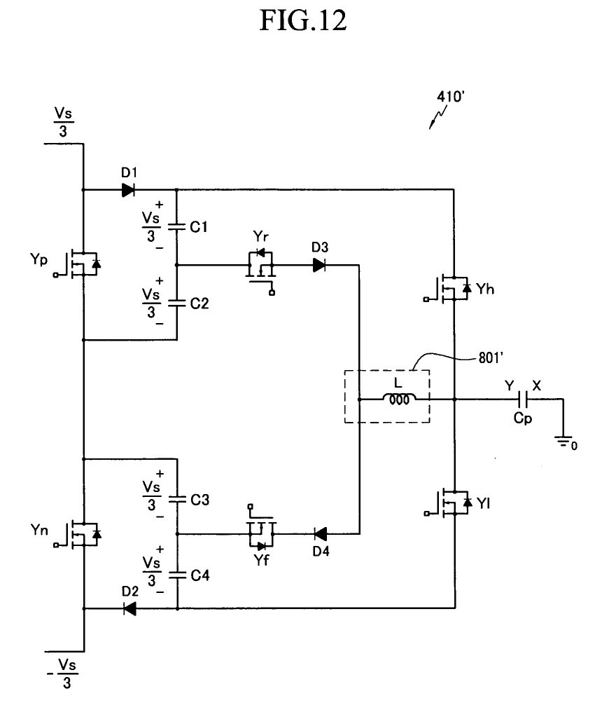

FIG. 8 shows a dotted line 801 around the inductors Lp, Ln. The dotted line 801 is an inductor element. In this particular embodiment, the inductor element may contain two inductors as shown in FIG. 8 or a single inductor as shown in FIG. 12.

In FIG. 8, the transistors Yp, Yn, Yr, Yf, Yh, Yl are illustrated as n-channel field effect transistors, particularly n-channel metal oxide semiconductor (NMOS) transistors, and a body diode may be formed in a direction from a source to a drain in the respective transistors Yp, Yn, Yr, Yf, Yh, Yl.

Rather than using the NMOS transistor, other transistors having similar functions may be used as transistors Yp, Yn, Yr, Yf, Yh, Yl. While the transistors Yp, Yn, Yr, Yf, Yh, Yl are respectively illustrated as a single transistor in FIG. 8, each of the transistors Yp, Yn, Yr, Yf, Yh, Yl may be formed by a plurality of transistors coupled in parallel. Furthermore, the transistors Yp, Yn, Yr, Yf, Yh, Yl may each be formed of more than one transistor coupled in series, which would reduce the requisite withstand voltage for each transistor.

The drain of the transistor Yp is coupled to the power source Vs/3 for supplying the Vs/3 voltage corresponding to one third of the high level voltage Vs of the sustain pulse, and the source of the transistor Yp is coupled to the drain of the transistor Yn. In addition, the source of the transistor Yn is coupled to the power source −Vs/3 for supplying the −Vs/3 voltage corresponding to one third of the low level voltage −Vs of the sustain pulse.

A first terminal of the capacitor C1 is coupled to the power source Vs/3, and a second terminal thereof is coupled to a first terminal of the capacitor C2. A second terminal of the capacitor C2 is coupled to the source of the transistor Yp. A first terminal of the capacitor C3 is coupled to a node of the source of the transistor Yp and the drain of the transistor Yn, and a second terminal thereof is coupled to a first terminal of the capacitor C4. A second terminal of the capacitor C4 is coupled to the power source −Vs/3. An anode of the diode D1 is coupled to the power source Vs/3, and a cathode thereof is coupled to the first terminal of capacitor C1. A cathode of the diode D2 is coupled to the power source −Vs/3, and an anode thereof is coupled to the second terminal of the capacitor C4.

In this case, the diodes D1, D2 respectively form charging paths for charging the capacitors C1, C2, C3, and C4 to be the Vs/3 voltage when the transistors Yn, Yp are respectively turned on. Rather than using the diodes D1, D2, and other elements (e.g., a transistor) may be used to form the charging path. In FIG. 8, it is assumed that the capacitors C1, C2, C3, and C4 are charged with the Vs/3 voltage.

The drain of the transistor Yh is coupled to the first terminal of the capacitor C1, the source of the transistor Yl is coupled to the second terminal of the capacitor C4, and the source of the transistor Yh and the drain of the transistor Yl are respectively coupled to the Y electrode of the panel capacitor Cp.

The drain of the transistor Yr is coupled to a node of the second terminal of the capacitor C1 and the first terminal of the capacitor C2, and the source of the transistor Yf is coupled to a node of the second terminal of the capacitor C3 and the first terminal of the capacitor C4.

The source of the transistor Yr is coupled to a first terminal of the inductor Lp, and the drain of the transistor Yf is coupled to a first terminal of the inductor Ln. A second terminal of the inductor Lp and a second terminal of the inductor Ln are respectively coupled to the Y electrode of the panel capacitor Cp.

An anode of the diode D3 is coupled to the source of the transistors Yr, and a cathode thereof is coupled to the first terminal of the inductor Lp. A cathode of the diode D4 is coupled to the drain of the transistor Yf, and an anode thereof is coupled to the first terminal of the inductor Ln.

The diode D3 interrupts a current path formed by a body diode of the transistor Yr, and sets a voltage increasing path for increasing the voltage at the Y electrode. The diode D4 interrupts a current path formed by a body diode of the transistor Yf, and sets a voltage decreasing path for decreasing the voltage at the Y electrode.

While it is illustrated that the inductors Lp, Ln are respectively coupled to the voltage increasing and decreasing paths, one single inductor may be coupled at an overlapped part of the voltage increasing and decreasing paths.

An operation of the sustain discharge driving circuit will now be described with reference to FIG. 9 and FIG. 10A to FIG. 10H.

Firstly, it is assumed that the transistors Yn, Yf are turned on before M1 begins.

Referring to FIG. 9 and FIG. 10A, at M1, the transistor Yf is turned off and the transistor Yl is turned on. Accordingly, the −Vs voltage is applied to the Y electrode through a current path \textcircled{1} of the Y electrode of the panel capacitor Cp, the transistor Yl, the capacitor C4, the capacitor C3, the transistor Yn, and the power source −Vs/3. That is, the −Vs voltage which is lower than the −Vs/3 source voltage by a sum 2Vs/3 of the voltages charged in the capacitors C3 and C4, is applied to the Y electrode.

In addition, when the transistor Yn is turned on while the transistor Yp is turned off, a current path \textcircled{2} of the power source Vs/3, the diode D1, the capacitor C2, the capacitor C1, the transistor Yn, and the power source −Vs/3 is formed, the 2Vs/3 voltage corresponding to a difference between voltages applied to the power sources Vs/3 and −Vs/3 is divided, and accordingly, the Vs/3 voltage is respectively charged in the capacitors C1 and C2. In this case, because a source voltage of the transistor Yh becomes the −Vs voltage through the current path \textcircled{1} and a drain voltage of the transistor Yh becomes the Vs/3 voltage through the current path \textcircled{2}, a 4Vs/3 voltage is applied between the source and the drain of the transistor Yh. Accordingly, the transistor Yh should have a withstand voltage of 4Vs/3.

In addition, because the source voltage of the transistor Yp is −Vs/3 voltage and the drain voltage of the transistor Yp is the Vs/3 voltage, the transistor Yp should have a withstand voltage of 2Vs/3.

Subsequently, at M2, because the transistor Yl is turned off and the transistor Yr is turned on, a resonance is formed in a current path \textcircled{3} of the power source −Vs/3, the transistor Yn, the capacitor C2, the transistor Yr, the diode D3, the inductor Lp, and the Y electrode of the panel capacitor Cp. Accordingly, the voltage of the Y electrode of the panel capacitor Cp is increased from the −Vs voltage to the Vs voltage. However, because a current may flow through the body diode of the transistor Yh when the voltage at the Y electrode is greater than the drain voltage (i.e., the Vs/3 voltage) of the transistor Yh, the voltage at the Y electrode is increased to the Vs/3 voltage through the current path \textcircled{3}.

Subsequently, at M3, because the transistor Yr is turned off and the transistor Yh is turned on, a current path \textcircled{4} of the power source Vs/3, the diode D1, the transistor Yh, and the Y electrode of the panel capacitor Cp is formed as shown in FIG. 10C, the Vs/3 voltage is applied to the Y electrode.

Subsequently, at a mode 4 (M4), because the transistor Yh is turned off and the transistors Yp, Yr are turned on, a resonance is generated in a current path \textcircled{5} of the power source Vs/3, the transistor Yp, the capacitor C2, the transistor Yr, the diode D3, the inductor Lp, and the Y electrode of the panel capacitor Cp as shown in FIG. 10D. Accordingly, the voltage at the Y electrode of the panel capacitor Cp is increased from the Vs/3 voltage to the Vs voltage.

In addition, as shown in FIG. 10D, because the transistor Yn is turned off, the transistor Yp is turned on, and a current path \textcircled{6} of the power source Vs/3, the transistor Yp, the capacitor C3, the capacitor C4, the diode D2, and the power source −Vs/3 is formed, the 2Vs/3 voltage corresponding to the difference between the voltages applied to the power source Vs/3 and the power source −Vs/3 is divided and the Vs/3 voltage is respectively applied to the capacitors C3 and C4.

At a mode 5 (M5), the transistor Yr is turned off, the transistor Yh is turned on, and the Vs voltage is applied to the Y electrode through a current path \textcircled{7} of the power source Vs/3, the transistor Yp, the capacitor C2, the capacitor C1, the transistor Yh, and the Y electrode of the panel capacitor Cp as shown in FIG. 10E. That is, the Vs voltage, which is higher than the Vs/3 source voltage by a sum 2Vs/3 of the voltages charged in the capacitors C1 and C2, is applied to the Y electrode.

In addition, because the −Vs/3 voltage is applied to the source of the transistor Yl through the current path \textcircled{6} and the Vs voltage is applied to the drain of the transistor Yl through the current path \textcircled{7}, the 4Vs/3 voltage is applied between the source and the drain of the transistor Yl. Accordingly, the transistor Yl should have a withstand voltage of 4Vs/3.

In addition, because the drain voltage of the transistor Yn is the Vs/3 voltage and the source voltage of the transistor Yn is the −Vs/3 voltage, the transistor Yn should have a withstand voltage of 2Vs/3.

At a mode 6 (M6), because the transistor Yh is turned off and the transistor Yf is turned on, a resonance is generated through a current path \textcircled{8} of the Y electrode of the panel capacitor Cp, the inductor Ln, the diode D4, the transistor Yf, the capacitor C3, the transistor Yp, and the power source Vs/3. Then, energy stored in the panel capacitor Cp is recovered to the power source Vs/3 through the inductor Lp, the voltage at the Y electrode is decreased from the Vs voltage to the −Vs voltage. However, because the current may flow to the Y electrode through the body diode of the transistor Yl when the voltage at the Y electrode is lower than the source voltage (i.e., the −Vs/3 voltage) of the transistor Yl, the voltage at the Y electrode is decreased to the −Vs/3 voltage through the current path \textcircled{8}.

Subsequently, at a mode 7(M7), because the transistor Yf is turned off and the transistor Yl is turned on, a current path \textcircled{9} of the Y electrode of the panel capacitor Cp, the transistor Yl, the diode D2, and the power source −Vs/3 is formed as shown in FIG. 10G, and the −Vs/3 voltage is applied to the Y electrode.

At a mode 8 (M8), because the transistor Yl is turned off and the transistors Yn, Yf are turned on, a resonance is generated through a current path \textcircled{10} of the Y electrode of the panel capacitor Cp, the inductor Ln, the diode D4, the transistor Yf, the capacitor C3, the transistor Yn, and the power source −Vs/3 as shown in FIG. 10H. Accordingly, the voltage at the Y electrode of the panel capacitor Cp is decreased from the −Vs/3 voltage to the −Vs voltage.

In addition, because the current path \textcircled{2} as shown in FIG. 10H is formed, the 2Vs/3 voltage corresponding to the difference between the voltages applied to the power source Vs/3 and the power source −Vs/3 is divided and the Vs/3 voltage is respectively applied to the capacitors C1 and C2.

As described, because the modes 1 to 8 are repeatedly performed a number of times that corresponds to a weight of the corresponding subfield, the Vs voltage and the −Vs voltage are alternately applied to the Y electrode. In addition, the transistors Yh, Yl should have a withstand voltage corresponding to ⅔ of the voltage swing applied to the Y electrode, i.e., a withstand voltage of 4Vs/3, and the transistors Yp, Yn should have a withstand voltage of 2Vs/3.

While generation of the driving waveform according to the third exemplary embodiment of the present invention has been described with reference to FIG. 10A to FIG. 10H, the driving waveform according to the first and second exemplary embodiments of the present invention may be generated by using the sustain discharge driving circuit shown in FIG. 8.

In further detail, in the sustain discharge driving circuit shown in FIG. 8, the drain of the transistor Yp can be coupled to a power source for supplying the 2Vs/3 voltage, and the source of the transistor Yn can be coupled to the power source for supplying the Vs/3 voltage. A Vs/6 voltage is respectively charged in the capacitors C1 and C2 when the transistor Yp is turned off and the transistor Yn is turned on, and the Vs/6 voltage is respectively charged in the capacitors C3 and C4 when the transistor Yn is turned off and the transistor Yp is turned on. Accordingly, the sustain pulse alternately having the Vs voltage and the 0V voltage may be applied to the Y electrode through the current paths shown in FIG. 10A to FIG. 10H. In this case, the sustain discharge driving circuit coupled to the X electrode has the same configuration as the sustain discharge driving circuit 410 coupled to the Y electrode. The sustain discharge driving circuit coupled to the X electrode applies the 0V voltage to the X electrode while the Vs voltage is applied to the Y electrode, and applies the Vs voltage to the X electrode while the Vs voltage is applied to the Y electrode.

In addition, in the sustain discharge driving circuit shown in FIG. 8, the drain of the transistor Yp can be coupled to a power source for supplying the Vs/6 voltage, and the source of the transistor Yn can be coupled to a power source for supplying the −Vs/6 voltage. In this case, the Vs/6 voltage is respectively charged in the capacitors C1 and C2 when the transistor Yp is turned off and the transistor Yn is turned on, and the Vs/6 voltage is respectively charged in the capacitors C3 and C4 when the transistor Yn is turned off and the transistor Yp is turned on. Accordingly, the sustain pulse alternately having the Vs/2 voltage and the −Vs/2 voltage may be applied to the Y electrode through the same paths as those shown in FIG. 10A to FIG. 10H. In this case, the sustain discharge driving circuit coupled to the X electrode has the same configuration as the sustain discharge driving circuit 410 coupled to the Y electrode. The sustain discharge driving circuit coupled to the X electrode may apply the sustain pulse alternately having the Vs/2 voltage and the −Vs/2 voltage to the X electrode in an opposite phase of the sustain pulse applied to the Y electrode.

FIG. 11 shows another embodiment of a sustain discharge driving circuit 405′ of a scan electrode driver for generating the driving waveform shown in FIG. 4. The sustain discharge driving circuit 405′ of FIG. 11 is identical to the sustain discharge driving circuit 405 of FIG. 5, except the resonance path \textcircled{3} shown in FIG. 7B and the resonance path \textcircled{6} shown in FIG. 7D travel through inductors Lp, Ln, respectively.

FIG. 11 shows a dotted line 501′ around the inductors Lp, Ln. The dotted line 501′ is an inductor element. In this particular embodiment, the inductor element may contain multiple inductors as shown in FIG. 11 or a single inductor as shown in FIG. 5.

FIG. 12 shows another embodiment of a sustain discharge driving circuit 410′ of a scan electrode driver according to a second exemplary embodiment. The sustain discharge driving circuit 410′ of FIG. 12 is identical to the sustain discharge driving circuit 410 of FIG. 8, except the resonance path \textcircled{3} of FIG. 10B, the resonance path \textcircled{5} of FIG. 10D, the resonance path \textcircled{8} of FIG. 10F, and the resonance path \textcircled{10} of FIG. 10H travel through the same inductor L.

FIG. 12 shows a dotted line 801′ around the inductor L. The dotted line 801′ is an inductor element. In this particular embodiment, the inductor element may contain one inductor as shown in FIG. 12 or multiple inductors as shown in FIG. 8.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiments of the present invention, a transistor having a lower withstand voltage may be used in a sustain discharge driving circuit.

What is claimed is:

1. A driving circuit for a plasma display having a plurality of first electrodes, the driving circuit comprising:
a first transistor having a first transistor first terminal coupled to a first power source for supplying a first voltage, and a first transistor second terminal;
a second transistor having a second transistor first terminal coupled to the first transistor second terminal and a second transistor second terminal coupled to a second power source for supplying a second voltage that is lower than the first voltage;
a first charging part having a first charging part first terminal coupled to the first power source and a first charging part second terminal coupled to the second transistor first terminal;
a second charging part having a second charging part first terminal coupled to the second power source and a second charging part second terminal coupled to the first transistor second terminal;
a first charging path including the first power source, the first charging part, and the second power source to charge the first charging part when the second transistor is turned on;
a second charging path including the first power source, the second charging part, and the second power source to charge the second charging part when the first transistor is turned on;
a third transistor having a third transistor first terminal coupled to the first charging part first terminal and a third transistor second terminal coupled to one of the plurality of first electrodes;
a fourth transistor having a fourth transistor first terminal coupled to the second charging part first terminal and a fourth transistor second terminal coupled to said one of the plurality of first electrodes;
a fifth transistor having a fifth transistor first terminal and a fifth transistor second terminal;
a sixth transistor having a sixth transistor first terminal and a sixth transistor second terminal;
a first resonance path including an inductor element coupled between the fifth transistor second terminal and to said one of the plurality of first electrodes; and
a second resonance path including the inductor element coupled between a sixth transistor first terminal and to said one of the plurality of first electrodes,
wherein when the fifth transistor first terminal and the sixth transistor second terminal are coupled to each other, both the fifth transistor first terminal and the sixth transistor second terminal are connected to ground, and when the fifth transistor first terminal and the sixth transistor second terminal are decoupled, the fifth transistor first terminal is connected to the first charging part and the sixth transistor second terminal is connected to the second charging part.

2. The driving circuit of claim 1, wherein when the fifth transistor first terminal is decoupled to the sixth transistor second terminal, the first charging part includes a first plurality of capacitors coupled in series and the second charging part includes a second plurality of capacitors coupled in series, and the fifth transistor first terminal is coupled to a first node of the first plurality of capacitors such that capacitors between the first charging part first terminal and the first node holds a charge voltage approximately equal to a charge voltage held by capacitors between the first node and the first charging part second terminal, and the sixth transistor second terminal is coupled to a second node of the second plurality of capacitors such that capacitors between the second charging part second terminal and the second node holds a charge voltage approximately equal to a charge voltage held by capacitors between the second node and the second charging part first terminal.

3. The driving circuit of claim 1, wherein the first resonance path includes a first diode and the inductor element, the first diode having an anode coupled to the fifth transistor second terminal, the inductor element being coupled to a cathode of the first diode and to a node of the third transistor and the fourth transistor, and
the second resonance path includes a second diode and the inductor element, the second diode having a cathode coupled to the sixth transistor first terminal, the inductor element being coupled to an anode of the second diode and to the node of the third transistor and the fourth transistor.

4. The driving circuit of claim 3, wherein the first charging path further includes a third diode having an anode coupled to the first power source and a cathode coupled to the first charging part first terminal, and
the second charging path further includes a fourth diode having a cathode coupled to the second power source and an anode coupled to the second charging part first terminal.

5. The driving circuit of claim 4, wherein the inductor element includes an inductor, the first resonance path and the second resonance path including the inductor.

6. The driving circuit of claim 4, wherein the inductor element includes a first inductor and a second inductor having the same inductance, the first resonance path including the first inductor, the second resonance path including the second inductor.

7. A driving circuit for a plasma display having a plurality of first electrodes, the driving circuit comprising:
a first transistor having a first transistor first terminal coupled to a first power supply for supplying a first voltage, and a first transistor second terminal;
a second transistor having a second transistor first terminal coupled to the first transistor second terminal, and a second transistor second terminal coupled to a second power supply for supplying a second voltage lower than the first voltage;
a first capacitor having a first capacitor first terminal coupled to the first transistor first terminal, and a first capacitor second terminal coupled to the first transistor second terminal;
a second capacitor having a second capacitor first terminal coupled to the second transistor first terminal, and a second capacitor second terminal coupled to the second transistor second terminal;
a first charging path including the first power supply, the first capacitor, the second transistor, and the second power supply, for charging the first capacitor when the second transistor is turned on;
a second charging path including the first power supply, the first transistor, the second capacitor, and the second power supply, for charging the second capacitor when the first transistor is turned on;
a third transistor coupled between one of the plurality of first electrodes and the first capacitor first terminal;
a fourth transistor coupled between said one of the plurality of first electrodes and the second capacitor second terminal;
a fifth transistor having a fifth transistor first terminal coupled to a third power supply for supplying a third voltage, which is lower than the first voltage but higher than the second voltage, and a fifth transistor second terminal coupled to said one of the plurality of first electrodes;
a sixth transistor having a sixth transistor first terminal coupled to the third power supply, and a sixth transistor second terminal coupled to said one of the plurality of first electrodes;
a voltage increasing path connected between the fifth transistor second terminal and said one of the plurality of first electrodes, for raising a voltage of said one of the plurality of first electrodes; and
a voltage decreasing path connected between the sixth transistor second terminal and said one of the plurality of first electrodes, for lowering the voltage of said one of the plurality of first electrodes.

8. The driving circuit of claim 7, wherein the first charging path includes a first diode having an anode connected to the first power supply and a cathode connected to the first capacitor first terminal, and
the second charging path includes a second diode having a cathode connected to the second power supply, and an anode connected to the second capacitor second terminal.

9. The driving circuit of claim 8, further comprising an inductor element coupled to a node of the fifth transistor second terminal and the sixth transistor second terminal,
wherein the voltage increasing path includes a third diode connected between the fifth transistor second terminal and the inductor element, and
the voltage decreasing path includes a fourth diode connected between the sixth transistor second terminal and the inductor element.

10. The driving circuit of claim 9, wherein:
in a state in which the second transistor and the fourth transistor are turned on, said one of the plurality of first electrodes is applied with a voltage corresponding to a difference between the second voltage and a voltage charged to the second capacitor;
in a state in which the second transistor and the fourth transistor are turned off and the fifth transistor is turned on, a voltage is increased of said one of the plurality of first electrodes;
in a state in which the fifth transistor is turned off, and the first transistor and the third transistor are turned on, a voltage is applied to said one of the plurality of first electrodes corresponding to a sum of the first voltage and a voltage charged to the first capacitor, and the second capacitor is charged with a voltage corresponding to a difference between the first voltage and the second voltage.

11. The driving circuit of claim 10, wherein:
in a state in which the first transistor and the third transistor are turned off and the sixth transistor is turned on, the voltage is decreased of said one of the plurality of first electrodes;
in a state in which the sixth transistor is turned off, and the second transistor and the fourth transistor are turned on, said one of the plurality of first electrodes is applied with a voltage corresponding to a difference between the second voltage and a voltage charged to the second capacitor, and the first capacitor is charged with a voltage corresponding to a difference between the first voltage and the second voltage.

12. A driving circuit for a plasma display having a plurality of first electrodes, the driving circuit comprising:
a first transistor having a first transistor first terminal coupled to a first power source for supplying a first voltage, and a first transistor second terminal;
a second transistor having a second transistor first terminal coupled to the first transistor second terminal and a second transistor second terminal coupled to a second power source for supplying a second voltage that is lower than the first voltage;
a first capacitor having a first capacitor first terminal coupled to the first transistor first terminal, and a first capacitor second terminal;
a second capacitor having a second capacitor first terminal coupled to the first capacitor second terminal and a second capacitor second terminal coupled to the second transistor first terminal;
a third capacitor having a third capacitor first terminal coupled to the first transistor second terminal, and a third capacitor second terminal;
a fourth capacitor having a fourth capacitor first terminal coupled to the third capacitor second terminal and a fourth capacitor second terminal coupled to the second power source;
a first charging path including the first power source, the first capacitor, the second capacitor, the second transistor, and the second power source, for charging the first capacitor and the second capacitor when the second transistor is turned on;
a second charging path including the first power source, the first transistor, the third capacitor, the fourth capacitor, and the second power source, for charging the third capacitor and the fourth capacitor when the first transistor is turned on;
a third transistor coupled between one of the plurality of first electrodes and the first capacitor first terminal;
a fourth transistor coupled between said one of the plurality of first electrodes and the fourth capacitor second terminal;
a fifth transistor having a fifth transistor first terminal coupled to the second capacitor first terminal and a fifth transistor second terminal coupled to said one of the plurality of first electrodes;
a sixth transistor having a sixth transistor first terminal coupled to the third capacitor second terminal and a sixth transistor second terminal coupled to said one of the plurality of first electrodes;
a first voltage increasing path including the second power source, the second transistor, the second capacitor, and the fifth transistor, the fifth transistor being coupled to said one of the plurality of first electrodes to increase a voltage of said one of the plurality of first electrodes;
a second voltage increasing path including the first power source, the first transistor, the second capacitor, and the fifth transistor, the fifth transistor being coupled to said one of the plurality of first electrodes to increase the voltage of said one of the plurality of first electrodes;
a first voltage decreasing path including the first power source, the first transistor, the third capacitor, and the sixth transistor, the sixth transistor being coupled to said one of the plurality of first electrodes to decrease the voltage of said one of the plurality of first electrodes; and
a second voltage decreasing path including the second power source, the second transistor, the third capacitor, and the sixth transistor, the sixth transistor being coupled to said one of the plurality of first electrodes to decrease the voltage of said one of the plurality of first electrodes.

13. The driving circuit of claim 12, wherein the first charging path further includes a first diode including an anode coupled to the first power source and a cathode coupled to the first capacitor first terminal, and
the second charging path further includes a second diode including a cathode coupled to the second power source and an anode coupled to the fourth capacitor second terminal.

14. The driving circuit of claim 13, further comprising an inductor element coupled to the fifth transistor second terminal, the sixth transistor second terminal, and to said one of the plurality of first electrodes,
wherein the first voltage increasing path and the second voltage increasing path include a third diode coupled between the fifth transistor second terminal and the inductor element, and the first voltage decreasing path and the second voltage decreasing path include a fourth diode coupled between the sixth transistor second terminal and the inductor element.

15. The driving circuit of claim 14, wherein:
in a state in which the second transistor and fourth transistor are turned on, a third voltage corresponding to a difference between the second voltage and a voltage charged in the third capacitor and the fourth capacitor is applied to said one of the plurality of first electrodes, and a voltage corresponding to a difference between the first voltage and the second voltage is charged in the first capacitor and the second capacitor;
in a state in which the fourth transistor is turned off and the fifth transistor is turned on, the voltage of said one of the plurality of first electrodes is increased;
in a state in which the fifth transistor is turned off and the third transistor is turned on, the first voltage is applied to said one of the plurality of first electrodes;
in a state in which the third transistor and the second transistor are turned off, and the first transistor and fifth transistor are turned on, the voltage of said one of the plurality of first electrodes is increased to a fourth voltage having a level that is higher than the third voltage, and a voltage corresponding to the difference between the first voltage and the second voltage is charged in the third capacitor and the fourth capacitor; and
in a state in which the fifth transistor is turned off and the third transistor is turned on, a voltage corresponding to a sum of the first voltage and a voltage charged in the first capacitor and the second capacitor is applied to said one of the plurality of first electrodes.

16. The driving circuit of claim 15, wherein:
in a state in which the third transistor is turned off and the sixth transistor is turned on, the voltage of said one of the plurality of first electrodes is decreased;
in a state in which the sixth transistor is turned off and the fourth transistor is turned on, the second voltage is applied to said one of the plurality of first electrodes, and a voltage;
in a state in which the fourth transistor and first transistor is turned off, and the second transistor and the sixth transistor are turned on, the voltage at said one of the plurality of first electrodes is further decreased to a fifth voltage, the fifth voltage being equal to the fourth voltage but of opposite polarity, and the voltage corresponding to the difference between the first voltage and the second voltage is charged in the first capacitor and the second capacitor; and
in a state in which the fourth transistor is turned on and the sixth transistor is turned off, the voltage corresponding to the difference between the second voltage and the voltage charged in the third capacitor and the fourth capacitor is applied to said one of the plurality of first electrodes.

17. A method of driving a plasma display device having a plurality of first electrodes, the method comprising:
applying a fourth voltage to the plurality of first electrodes through a first power supply for supplying a first voltage and through a first capacitor carrying a first capacitor voltage;
increasing a first electrode voltage to the plurality of first electrodes through a first resonance path, the first resonance path including a second power supply and an inductor element, the second power supply supplying a second voltage higher than the first voltage;
applying a fifth voltage to the plurality of first electrodes through a third power supply for supplying a third voltage and through a second capacitor carrying a second capacitor voltage, the third voltage being higher than the second voltage; and
decreasing the first electrode voltage through a second resonance path, the second resonance path including the second power supply and the inductor element.

18. The method of claim 17, wherein:
the first resonance path further includes a first transistor coupled between the second power supply and the inductor element; and
the second resonance path further includes a second transistor coupled between the second power supply and the inductor element.

19. The method of claim 18, wherein applying the voltage to the plurality of first electrodes through the first power supply includes charging the second capacitor with the second capacitor voltage through a first charging path including the third power supply, the second capacitor, and the first power supply.

20. The method of claim 19, wherein applying the voltage to the plurality of first electrodes through a third power supply includes charging the first capacitor with the first capacitor voltage through a second charging path including the third power supply, the first capacitor, and the first power supply.

21. A method of driving a plasma display device having a plurality of first electrodes, the method comprising:
applying a fourth voltage to the plurality of first electrodes through a first power source for supplying a first voltage and through a first capacitor carrying a first capacitor voltage and a second capacitor carrying a second capacitor voltage;
increasing the first electrode voltage to the plurality of first electrodes through a first resonance path, the first resonance path including the first power source and an inductor element;
applying a fifth voltage to the plurality of first electrodes by the second power source for supplying a second voltage that is higher than the first voltage;
further increasing the first electrode voltage through a second resonance path, the second resonance path including the second power source and the inductor element;
applying a sixth voltage to the plurality of first electrodes through the second power source and through a third capacitor charged with a third capacitor voltage and a fourth capacitor charged with a fourth capacitor voltage;
decreasing the first electrode voltage through the a third resonance path, the third resonance path including the second power source and the inductor element;
applying a seventh voltage to the plurality of first electrodes by the first power source; and
further decreasing the first electrode voltage through a fourth resonance path, the fourth resonance path including the first power source and the inductor element.

22. The method of claim 21, wherein:
the first resonance path further includes a first transistor coupled between the first power source and the inductor element;
the second resonance path further includes the first transistor coupled between the second power source and the inductor element;
the third resonance path further includes a second transistor coupled between the second power source and the inductor element; and
the fourth resonance path further includes the second transistor coupled between the first power source and the inductor element.

23. The method of claim 22, wherein increasing or decreasing the voltage to the plurality of first electrodes through the second resonance path or the third resonance path further includes charging the first capacitor voltage in the first capacitor and the second capacitor voltage in the second capacitor through a charging path including the second power source, the first capacitor, the second capacitor, and the first power source.

24. The method of claim 23, wherein increasing or decreasing the voltage to the plurality of first electrodes through the first resonance path or the fourth resonance path further includes charging the third capacitor voltage in the third capacitor and the fourth capacitor voltage in the fourth capacitor through a charging path including the second power source, the third capacitor, the fourth capacitor, and the first power source.

25. The method of claim 24, wherein the inductor element includes a first inductor and a second inductor, the first resonance path including the first inductor, the second resonance path including the first inductor, the third resonance path including the second inductor, and the fourth resonance path including the second inductor.

26. The method of claim 24, wherein the inductor element includes an inductor, the first resonance path, the second resonance path, the third resonance path, and the fourth resonance path including the inductor.
